(19) United States
(12) Patent Application Publication
(10) Pub. No.: US 2003/0142841 A1
(43) Pub. Date: Jul. 31, 2003

(54) Optical signal transmission between a hearing protector muff and an ear-plug receiver

(75) Inventor: Thomas E. Wiegand, Somerville, MA (US)

Correspondence Address: HALE AND DORR, LLP, 60 STATE STREET, BOSTON, MA, 02109

(73) Assignee: Sensimetrics Corporation, Somerville, MA (US)

(21) Appl. No.: 10/060,158

(22) Filed: Jan. 30, 2002

(51) Int. Cl. H04R 25/00

(52) U.S. Cl. 381/172; 381/370; 381/371; 381/372

(57) ABSTRACT

A hearing protector assembly has a muff and an ear-plug for hearing protection while allowing reception of audio communication. The muff has a receiver for audio signals, a modulation circuit, and a set of LEDs for transmitting the audio signal as a light signal. The ear-plug has a photovoltaic cell for receiving the light signals, a demodulator circuit, and a transducer for converting the received signal into an acoustic signal.

### STATEMENT OF GOVERNMENT RIGHTS

The United States Government has rights in this invention as provided for by the terms of Grant Number R44 OH04132 awarded by the National Institute for Occupational Safety and Health.

### BACKGROUND OF THE INVENTION

The present invention pertains to hearing protectors.

Hearing protectors are designed to prevent external sound from reaching the ears. They are used in a variety of situations, and are used, for example, by people who are exposed to high levels of noise for extended periods of time. They can also be used during hearing testing, in which case they are used to reduce the interfering effects of background noise in a test environment.

The two most common forms of hearing protectors are muffs and earplugs, which can be used separately or together for maximal sound attenuation. In many situations, it is desirable for users of hearing protectors (such as helicopter pilots) to continue to receive audio communications while blocking harmful sounds. Some types of muff-type protectors are therefore equipped with earphones to form a communication headset. If both ear-plugs and muffs are needed but the user must also receive audio signals, a communication headset does not serve the purpose because acoustic signals are attenuated by the plugs before they reach the user's ears.

### SUMMARY OF INVENTION

The invention relates to hearing protectors and to methods for providing acoustic signals to users wearing hearing protectors. Described embodiments include an apparatus and method that use optical signal transmission between a signal transmitter in a hearing protecting muff and a receiver connected to an ear-plug and inserted into the ear canal.

The embodiments of the present invention can include at least some of the following benefits: the circuitry in the ear-plug requires no battery and can operate at low power levels; optical transmissions are easily contained within the muff and therefore do not pose a risk of interfering with other systems; and an optical receiver can be made immune to interference from external electromagnetic fields. The method of transmission used in the present invention is simple and efficient. The light can be transmitted with light emitting diodes (LEDs) powered by a simple battery and therefore provide many hours of use. Other features and advantages will become apparent from the following detailed description, drawings, and claims.

### BRIEF DESCRIPTION OF THE DRAWINGS

FIG. 1 is a pictorial representation of an embodiment of the assembly of the invention.

FIG. 2 is a block diagram according to an embodiment of the invention.

FIG. 3 is a schematic of a circuit according to an embodiment of the invention.

### DETAILED DESCRIPTION

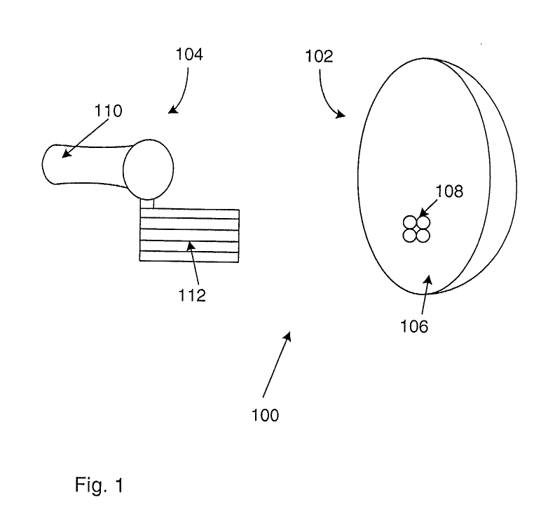

FIG. 1 shows a pictorial view of a hearing protection system 100 which includes a muff assembly 102 and ear-plug assembly 104. Muff assembly 102 includes a sound-isolating muff 106 and LEDs 108. Muff 106 has a simple shell and may have a custom fit enclosure or active noise cancellation circuitry (not shown). Muff 106 is worn over a user's ear. Ear-plug assembly 104 includes plug 110, a mono-crystalline silicon photovoltaic (PV) cell 112, and circuitry. Plug 110 can be made of any suitable compliant material in a generic shape or can be a custom-cast earmold for improved fit and sealing ability. Plug 110 is inserted into the user's ear canal, while PV cell 112 is outside the ear canal.

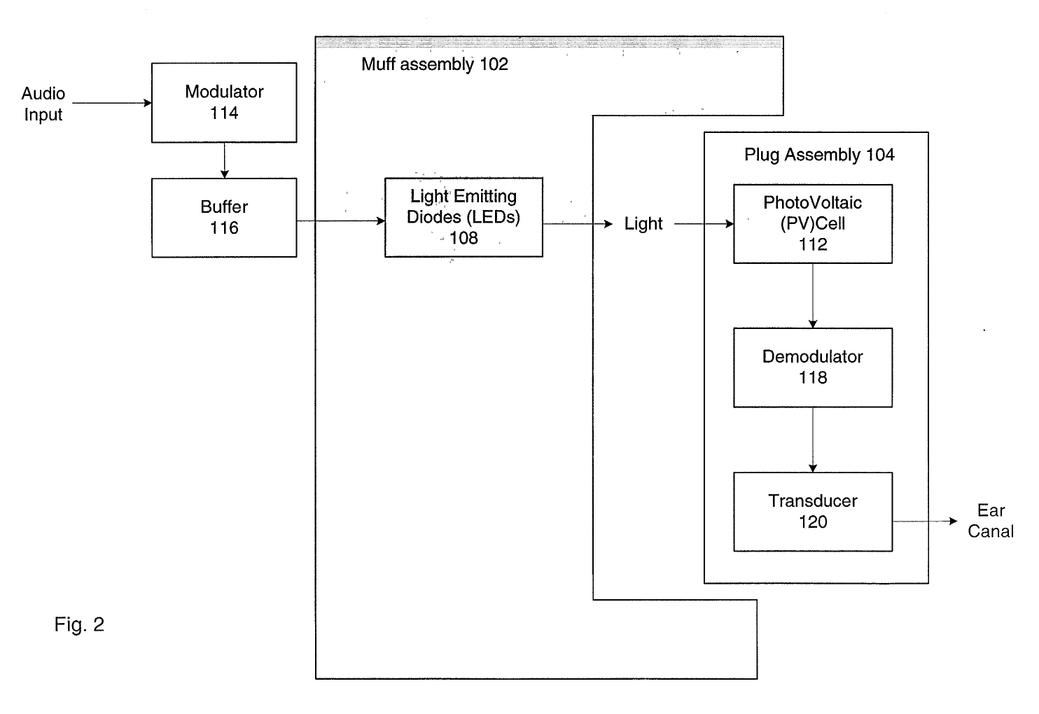

Referring also to FIG. 2, an external audio input is provided to modulator 114 for modulating the signal, and then to a buffer 116. The buffered signal drives a light source, such as LEDs 108, to emit light signals representative of the audio input. Plug assembly 104 has a PV cell 112 that is positioned to receive the light signals from LEDs 108. PV cell 112 receives the light signals from LEDs 108 and passes them to a demodulator 118 and a miniature loudspeaker transducer 120 to provide to the user an audio output that is representative of the audio input. Demodulator 118 and transducer 120 are thus part of plug assembly 104.

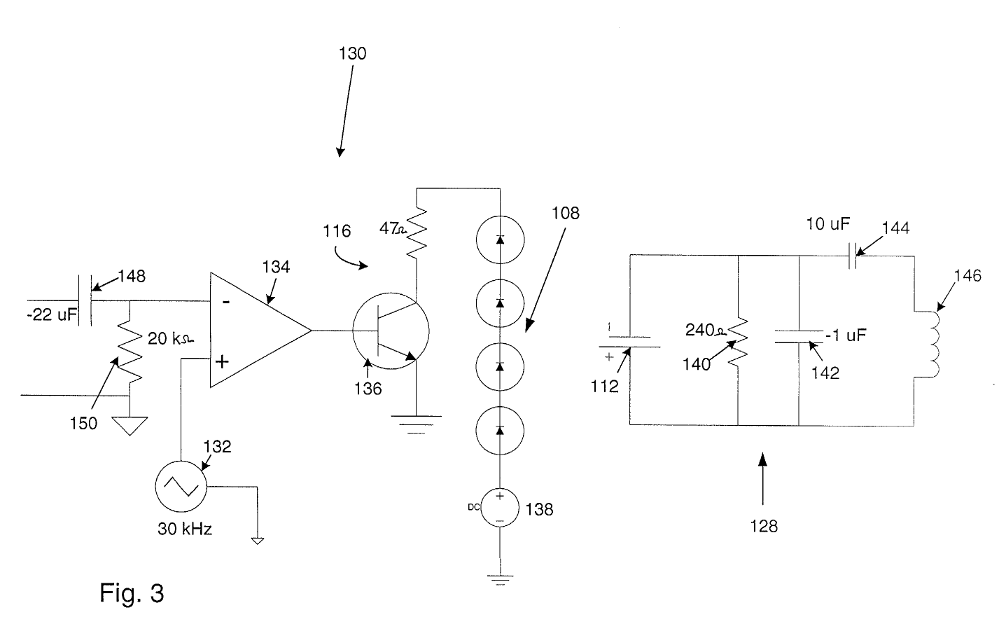

FIG. 3 shows an example of a schematic of circuits 130 and 128 that correspond to circuits shown in block form in FIG. 2. An audio input signal is provided to a modulator 114, such as a pulse width modulator (PWM). The PWM includes an input circuit consisting of a high pass filter and load, formed by capacitor 148 and resistor 150, a comparator 134, and an oscillator 132. The filtered input is provided to the inverting input of comparator 134. The non-inverting input to comparator 134 is a 30 kHz triangle wave carrier signal generated by oscillator 132.

Muff assembly 102 may physically include modulator 114 and buffer 116, or may be physically remote from them. Unless otherwise indicated, these circuit components are considered part of the muff assembly even if physically remote.

The modulated audio signal is provided to buffer 116, which is formed in this example by a transistor 136 and a low-output resistor. Transistor 116 has one side coupled to ground, the other side coupled to one side of LEDs 108, and a control lead coupled to the output of comparator 134. A power source 138, such as a 9-volt battery, is coupled to the other side of LEDs 108. As transistor 136 turns on and off in response to the comparator, light output of LEDs 108 follows.

As shown in FIG. 3, ear-plug circuit 128 includes a parallel connection of PV cell 112, a load resistor 140, and capacitor 142. Load resistor 140 and capacitor 142 form a low pass filter that serves as demodulator 118 of FIG. 2, and are in parallel with a series coupling capacitor 144 and a low impedance hearing aid transducer 146.

With low impedance, transducer 146 effectively utilizes the power received from PV cell 112. The impedance is preferably on the order of 50 ohms rather than a more common 500 ohm. The demodulation/filtering that occurs in circuit 128 is determined partly by the discrete capacitor and resistor components and partly by the intrinsic characteristics of the PV cell (internal resistance, capacitance) and acoustic transducer (resistance, inductance, acoustical parameters). Using the component values specified to drive an acoustic circuit replicating a human ear canal, one can achieve 90 dB SPL and distortion levels under 1%.

Circuitry 128 of PV cell 112 is compact enough to be enclosed in the space between muff 106 and the wearer's ear without adversely affecting the fit or effectiveness of muff 106. The ear plus circuitry can be provided, for example, on the back of the PV cell using surface mount technology, or combined with the PV cell in a three-dimensional circuit board.

Due to propagation characteristics inherent in optical transmission, the present invention is immune to interference from adjacent transmitters and does not cause interference for other apparatus. This feature is useful because it allows for binaural presentation (i.e. two independent channels, one for each ear), and also eliminates interaction between any one system and neighboring systems.

For binaural presentation over separate channels, each muff would have its own modulator and buffer, although it would be preferable to share the oscillator and power supply. A monaural system provided to both ears would share one modulator and buffer, but have separate LEDs and ear-plug assemblies.

Other embodiments of the present invention are within the claims. For example, the light used in transmission can be visible or infrared, with red being particularly useful for demonstration purposes. While LEDs have been used as an exemplary light source, other sources could be used, preferably a source that is capable of being modulated at an adequately high frequency to accommodate the modulation scheme. While one photocell per ear-plug assembly is preferred, a stack of photocells can be used. The cells can be rectangular in shape or shaped to conform to the ear. Other forms of modulation, such as pulse density and frequency modulation, can be used as an alternative to pulse width modulation. The frequency of the carrier waveform used for modulation can be different from the 30 kHz shown, but should be above the Nyquist frequency of 15 kHz and not be too high to create loss from capacitive effects in the PV cell.

What is claimed is:

1. A combination hearing protector/communication system assembly that attenuates undesired external sounds and delivers audio to the user, comprising:
a first hearing protecting muff for attenuating sounds and receiving desired acoustic signals, the muff enclosing an optical transmitter for transmitting optical signals representative of the received acoustic signals; and
an ear-plug assembly including an optical receiver for receiving the transmitted optical signals and a transducer for providing acoustic signals representative of the acoustic signals received by the muff.

2. The assembly of claim 1, wherein the optical transmitter includes one or more light emitting diodes (LEDs).

3. The assembly of claim 2, wherein the muff receives modulated acoustic signals from a remote modulator and provides the signals to the LEDs.

4. The assembly of claim 2, wherein the muff incorporates a modulator for providing modulated acoustic signals to the LEDs.

5. The assembly of claim 1, wherein the optical receiver includes a photovoltaic cell.

6. The assembly of claim 5, wherein the ear-plug assembly includes a demodulator and a transducer, the photovoltaic cell providing signals to the demodulator, which provides demodulated signals to the transducer.

7. The assembly of claim 1, further comprising a second muff and a second ear-plug, each substantially the same as the first.

8. The assembly of claim 7, wherein the first and second muffs receive and provide signals over separate channels.

9. The assembly of claim 8, wherein each muff has separate modulator and buffer circuits.

10. The assembly of claim 9, wherein the circuits for the muffs share use of an oscillator.

11. A method for providing hearing protection and desired audio signals, comprising:
a hearing protecting muff receiving an audio signal;
converting the audio signal to a light signal;
transmitting the light signal from the muff to the ear-plug;
an ear-plug with a detector receiving the light signals;
converting the optical signal to an acoustic signal.

12. The method of claim 11, wherein the transmitting includes transmitting one of visible or infrared light.

13. The method of claim 11, wherein the converting processes include pulse width modulation and demodulation.

14. The method of claim 11, further comprising receiving an audio signal with a second muff, and transmitting a light signal to a second ear-plug over a separate channel.

15. A hearing protection system including a muff and an ear-plug, with optical communication therebetween.
